(19) United States
(12) Patent Application Publication
(10) Pub. No.: US 2004/0227305 A1
(43) Pub. Date: Nov. 18, 2004

(54) Process and apparatus for joining by welding at least two metallic sheets and joints obtained

(76) Inventors: Daniel F. Claveyrollas, Le Palais sur Vienne (FR); Loic M. Sage, Weinheim (DE)

Correspondence Address: HARNESS, DICKEY & PIERCE, P.L.C., P.O. BOX 828, BLOOMFIELD HILLS, MI, 48303, US

(21) Appl. No.: 10/770,860

(22) Filed: Feb. 3, 2004

(30) Foreign Application Priority Data
Feb. 17, 2003 (FR) 03 01869

(51) Int. Cl. F02F 11/00

(52) U.S. Cl. 277/592

(57) ABSTRACT

A method for joining at least two metallic sheets superposed to form a stack, at least one of which bears an electrically insulating coating on at least one face. The method particularly is for producing multisheet gaskets, characterized in that the method consists of placing the stack of sheets between an anvil and a sonotrode, applying a given pressure to the stack, and while applying the pressure, emitting an ultrasonic wave to cause localized melting of the metal constituting the sheets opposite the sonotrode.

### CROSS-REFERENCE TO RELATED APPLICATIONS

This application claims the benefit of French Patent Application 03 01869, filed Feb. 17, 2003. The disclosure of the above application is incorporated herein by reference.

### FIELD OF THE INVENTION

The present invention relates to a method and an apparatus for welding at least two metallic sheets.

### BACKGROUND OF THE INVENTION

The following description will deal with a specific example of a flat gasket, but numerous other applications, and cylinder head gaskets in particular, can be envisaged, as will be indicated further below.

Metallic gaskets that comprise several thin sheets of metal are known. The thickness of metallic gaskets range from a few tens of millimeters to one or two millimeters. These metallic sheets are cut out and then superposed. If necessary, they are provided with profile deformations to obtain ribs capable of focusing compression stresses and forming sealing barriers based on sophisticated mapping.

In general, certain flat gaskets, such as the gaskets of leakage collectors, are fabricated from several metallic sheets. In the same manner are also obtained multi-sheet cylinder head gaskets mounted on numerous internal combustion engines of motor vehicles. In this case, the head gaskets comprise a superposition of several sheets of a different nature and different thicknesses, depending on the type of engine.

It is advantageous to keep the sheets of such a stack perfectly positioned and, for this purpose, to subject them to spot welding to join them to one another.

Spot welding is carried out by use of electric energy, namely by generating a major potential difference between two electrodes disposed on the two sides of the stack of sheets, thus forming an electric arc which causes localized melting of the metallic sheets and thus welding.

A problem arises when the metallic sheets are covered by an insulating material. In fact, to be able to help compensate for the defects caused by the relative movement of the head gasket and the engine block as a result of dilation and to ensure micro-tightness, the sheets are in some cases covered with a thin layer of a coating. The material constituting the coating is a product of carbon chemistry in the form of a resin or elastomer having specific properties with respect to the coefficient of friction, hardness, sealing ability, and processing conditions.

Molybdenum disulfide is a coating currently in use, and its insulating power is such that electric spot welding is impossible. The coating acts as a dielectric.

The solutions of this problem are based on the use of coatings that have an insulating matrix, but contain conductive particles as a result of which they become electric conductors. Such coatings make it possible to use the known techniques of electric spot welding. Their drawback is that they need to have a special composition, and that they require the introduction of metallic particles into an antifriction material, which is not satisfactory. Further, the particle distribution must be highly uniform to give quality welds at each intended point in reproducible manner, which imposes other constraints.

### SUMMARY OF THE INVENTION

Hence, the present invention proposes an alternative by making use of a method of joining metallic sheets coated with an insulating material, a method for which it is not necessary to modify the composition of the coating and which is regular and reproducible.

To this end, the present invention provides a method of joining at least two metallic sheets superposed to form a stack, particularly a multi-sheet gasket. At least one of the metallic sheets bears an electrically insulating coating on at least one side. The method includes placing the stack of sheets between an anvil and a sonotrode, applying a given pressure to the stack and, while applying pressure, emitting an ultrasonic wave to cause localized melting of the metallic sheets opposite the sonotrode.

According to another feature of the present invention, the sonotrode is provided with handling means that make it possible to apply a pressure to the stack. Transducing means capable of generating an ultrasonic wave which the sonotrode transmits to the stack are also provided.

Further, an amplifier is preferably interposed between the transducing means and the sonotrode.

The present invention also relates to a flat multi-sheet gasket comprising at least one welding spot between two sheets. The welding spot is obtained by local melting induced by an ultrasonic wave.

More particularly, the invention relates to a cylinder head gasket comprising at least one welding spot obtained by local melting caused by an ultrasonic wave.

The welding spots are made at the periphery of a cylinder hole and/or the periphery of the stack of sheets.

The invention also relates to the use of an ultrasonic wave to ensure spot joining of a stack of at least two metallic sheets, of which at least one sheet comprises an electrically insulating coating on at least one of its faces.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of the apparatus used to carry out the method according to a principle of the present invention;

FIG. 2 is a top view of a cylinder head gasket and of the localization of the welding spots according to a principle of the present invention; and

FIG. 3 is a cross-sectional view along line 3-3 of FIG. 2.

### DETAILED DESCRIPTION OF THE PREFERRED EMBODIMENTS

The following description of the preferred embodiment(s) is merely exemplary in nature and is in no way intended to limit the invention, its application, or uses.

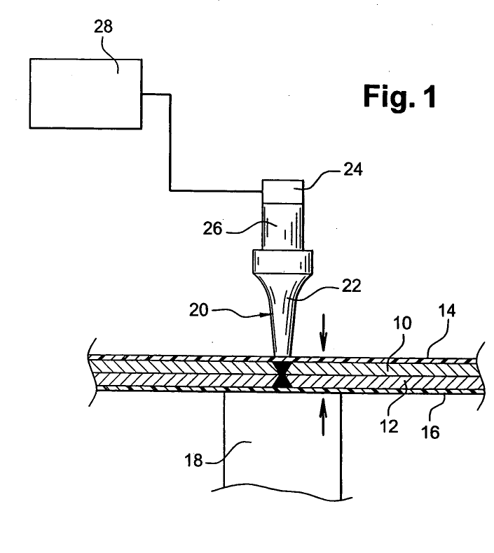

FIG. 1 shows a flat gasket which in the present example contains two metallic sheets 10 and 12. In this embodiment, the sheets consist of carbon steel, stainless steel, crude steel, aluminum steel, galvanized steel, nickel steel or aluminum.

A thickness of the sheets is preferably between 0.1 and 2.0 millimeters.

Each of these sheets is covered on its outer face with a coating 14 and 16 of an electrically insulating material which can have multiple roles and functions. This coating is preferably one of molybdenum disulfide, ethylene propylene diene monomer (EPDM), nitrile butadiene rubber (NBR), silicone, a lacquer or a varnish.

The coating is preferably from 10 to 1000 μm thick.

The two sheets are placed between an anvil 18 of a large mass and a tool 20. It should be understood that the different materials shown are not to scale in order to show the details of the sheets.

The anvil has a surface sufficient to receive the sheets and to support the pressure applied by the tool, as will be explained further below. Its large mass enables it to dissipate the energy transmitted through tool 20. The tool 20 is a sonotrode 22 with a profile that may be adapted depending on the function of the welding spots to be obtained. The sonotrode 22 has a mechanical strength enabling it to exert pressure on the two sheets 10 and 12, while the anvil 18 has the function of absorbing the stress.

The sonotrode 22 is intimately associated with an ultrasound-producing transducer 24.

To make it possible to concentrate and focus the emitted waves so that the maximum amplitude is located at the interface between the metallic sheets 10 and 12, an amplifier 26 for the waves emitted by the transducer is provided. The amplifier 26 is interposed between the transducer 24 and the sonotrode 22.

The transducer 24 itself is supplied by a generator 28 that creates the initial electric oscillations. The operating frequency of the generator is preferably between 15 KHz and 3 MHz.

The method consists of placing the sheets between the sonotrode 22 and the anvil 18, and generating the ultrasound.

The ultrasound passes through the coating 14 and 16 which is an electric insulator, but which also presents damping characteristics.

Nevertheless, the ultrasound causes friction between the two opposite metallic faces of the sheets 10 and 12, and under the simultaneously applied pressure, the two surfaces melt in spots opposite the sonotrode 22, which leads to spot welding of the two opposite sheets 10 and 12.

The time period during which pressure is exerted and during which the ultrasonic wave is emitted can be determined as a function of the materials selected, and can be determined by those skilled in the art.

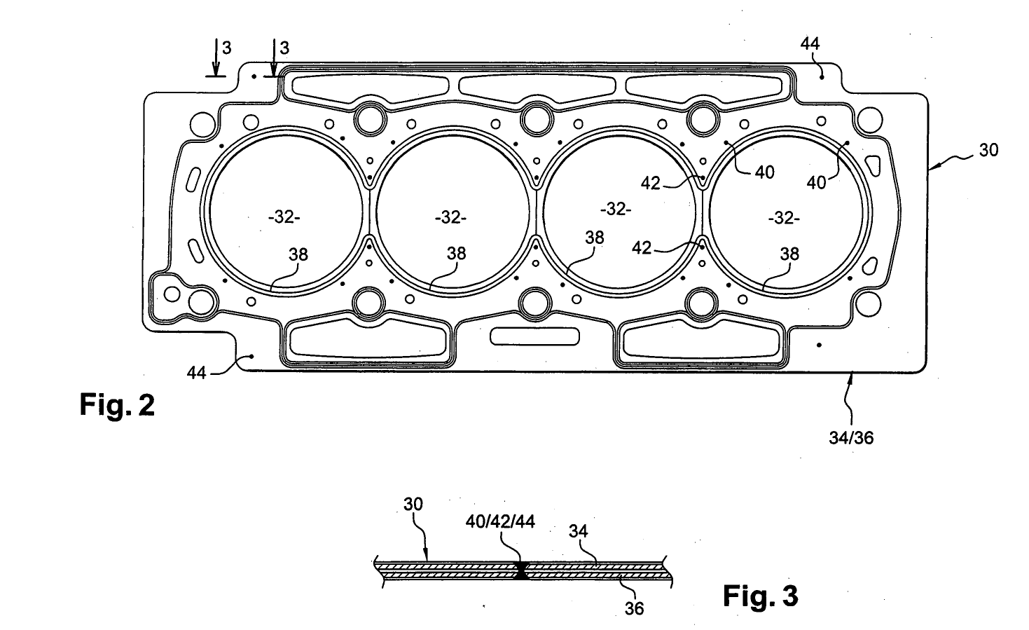

Also, the position of the welding spot may be selected as a function of the work-piece and the needs associated with the use of the sheets 10 and 12. In FIG. 2, a cylinder head gasket 30 for a four-cylinder engine which comprises four cylinder holes 32 with a stack of two sheets 34 and 36 is depicted.

Each cylinder hole 32 is provided at its periphery with a mounting device 38.

Joining spots 40 obtained by ultrasonic welding are disposed at the periphery of the cylinder holes and certain spots, 42, are disposed in the vicinity of the intercylinder zones. Other spots, 44, are disposed at the periphery of the stack to ensure general stability.

On the cross-section along line 3-3 (FIG. 3), one can find the joining points obtained by localized melting opposite the sonotrode.

It should be noted that during this operation, the sheets that face each other and their coatings do not undergo degradation outside the pressure surface of the tool.

Further, there are numerous other applications in addition to the welding of gaskets that can be accomplished by the present invention. In particular, the present invention is useful when two metallic work-pieces need to be joined to one another after painting, because the paint acts as a di-electric.

The present invention is useful in this manner because painting is often done after the assembly, but this requires more complicated operations, in particular the masking of certain parts.

Once the parameters that depend on the thickness and the nature of the sheet materials and coatings have been determined, one skilled in the art will find that the method is reproducible, which is advantageous in industrial applications, particularly those followed by important quality control.

In the case of cylinder head gaskets, the quality is quite important, because the deficiency of such a gasket can induce major degradations of the engine of a motor vehicle at a considerable cost.

In the presented examples, the coating is present on only one of the two faces of each sheet, but it is conceivable to find sheets with both faces coated. Nevertheless, welding is achieved thanks to the method of welding based on the use of ultrasound.

Another advantage of this technique is the safety aspect. In fact, in a solvent or resin environment, ultrasound does not cause short circuits or sparks that are likely to cause fire. In regards to the personnel in charge of the equipment, they are not at any risk of a luminous flash or of hazards linked to the handling of high electric tensions.

Finally, the apparatus can easily be introduced into the middle of a manufacturing line.

The description of the invention is merely exemplary in nature and, thus, variations that do not depart from the gist of the invention are intended to be within the scope of the invention. Such variations are not to be regarded as a departure from the spirit and scope of the invention.

1. A method of joining at least two metallic sheets superposed to form a stack, at least one of the metallic sheets bearing an electrically insulating coating on at least one face, comprising:
placing the stack of sheets between an anvil and a sonotrode;
applying a given pressure to the stack; and
while applying the pressure, emitting an ultrasonic wave to cause localized melting of the sheets opposite the sonotrode.

2. An apparatus for joining at least two metallic sheets superposed to form a stack, at least one of the metallic sheets bearing an electrically insulating coating on at least one face, comprising:
at least one anvil supporting the stack; and
a sonotrode;
wherein the anvil and/or the sonotrode having handling means to apply pressure to the stack, and transducing means to generate an ultrasonic wave which is transmitted by the sonotrode to the stack.

3. The apparatus for joining at least two sheets according to claim 2, further comprising an amplifiers interposed between the transducing means and the sonotrode.

4. A flat multi-sheet gasket comprising:
a stack of at least two sheets of which at least one sheet includes an electrically insulating coating on at least one face; and
at least one welding spot between the two sheets obtained by localized melting caused by an ultrasonic wave.

5. A cylinder head gasket comprising:
a stack of at least two metallic sheets, at least one sheet of which comprises an electrically conductive coating on at least one face; and
at least one welding spot, the welding spot obtained by localized melting caused by an ultrasonic wave.

6. The Cylinder head gasket according to claim 5, wherein the at least one welding spot is provided at a periphery of a cylinder hole.

7. The Cylinder head gasket according to claim 5, wherein that the at least one welding spot is provided at a periphery of the sheet stack.

8. (Cancelled)

9. A method for manufacturing a multi-sheet gasket comprising:
providing at least two sheets including an insulating coating;
placing the sheets between an anvil and a sonotrode;
emitting an ultrasound from the sonotrode; and
spot-welding the two sheets with the ultrasound at a plurality of points throughout a surface of the sheets.

10. The method according to claim 9, further comprising focusing the ultrasound so that a maximum amplitude is located at an interface between sheets.

11. The method according to claim 10, further comprising causing friction between the two sheets; and
under simultaneously applied pressure, melting the sheets in spots opposite the sonotrode.
